(19) United States
(12) Patent Application Publication
(10) Pub. No.: US 2013/0033407 A1
(43) Pub. Date: Feb. 7, 2013

(54) ANTENNA AND METHOD FOR MANUFACTURING SAME

(71) Applicants: JungHoon Chae, Suwon (KR); JungMin Kim, Suwon (KR)

(72) Inventors: JungHoon Chae, Suwon (KR); JungMin Kim, Suwon (KR)

(73) Assignees: AMERICAN AUDIO COMPONENTS INC., La Verne, CA (US); AAC ACOUSTIC TECHNOLOGIES (SHENZHEN) CO., LTD., Shenzhen (CN)

(21) Appl. No.: 13/531,980

(22) Filed: Jun. 25, 2012

(30) Foreign Application Priority Data
Aug. 4, 2011 (CN) 201110222431.9

(51) Int. Cl. H01Q 1/00; B44C 1/22

(52) U.S. Cl. 343/787; 216/83

(57) ABSTRACT

A method for manufacturing an antenna is disclosed, and the method includes the steps of: providing a ceramic substrate and forming an antenna pattern on the ceramic substrate using screen printing with metallic material, co-firing the ceramic substrate and the antenna pattern by a high temperature, treating the ceramic substrate by chemical wet-etching process, providing a ferrite plate with an adhesive layer disposed on a first face thereof, pasting the ceramic substrate to the ferrite plate with the antenna pattern attached to the adhesive layer, and detaching the ferrite plate from the ceramic substrate with the antenna pattern remained on the ferrite plate.

### FIELD OF THE INVENTION

The present disclosure relates to radio frequency identification technologies, and more specifically to an antenna and a method for manufacturing the antenna.

### DESCRIPTION OF RELATED ART

With the rapidly development of radio frequency identification technologies, radio frequency identification (RFID) tags are widely used in various fields such as distribution, logistic, material handling industries, and non-contact integrated circuits.

A related radio frequency identification tag includes an antenna and an integrated circuit connected with the antenna for providing object information. And there are various methods provided for manufacturing a radio frequency antenna, such as entwining enameled wires, printing silk screen, or making flexible printed circuit boards (FPCB).

A conventional antenna which is made of FPCB consists of an insulator layer, a conductive layer having an antenna pattern, and adhesive tapes disposed therebetween. However, the cost for manufacturing such an antenna is increased because the cost of the FPCB unit is high and the FPCB is required for at least two adhesive tapes. Further, it's difficult to make a thin antenna by using FPCB because a typical height of FPCB is at least 0.1 mm and the total thickness of the antenna is accordingly increased. Otherwise, the antenna made of FPCB is easy to be broken because of the poor flexibility of the FPCB.

Therefore, it is desirable to provide a new antenna and a new method which can overcome the above-mentioned problems.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric and exploded view of an antenna in accordance with an exemplary embodiment of the present disclosure;

FIG. 2 shows an antenna pattern forming on a ceramic substrate in FIG. 1.

FIG. 3 shows the ceramic substrate ready to be attached to a ferrite plate.

FIG. 4 shows the antenna pattern disposed on the ferrite plate.

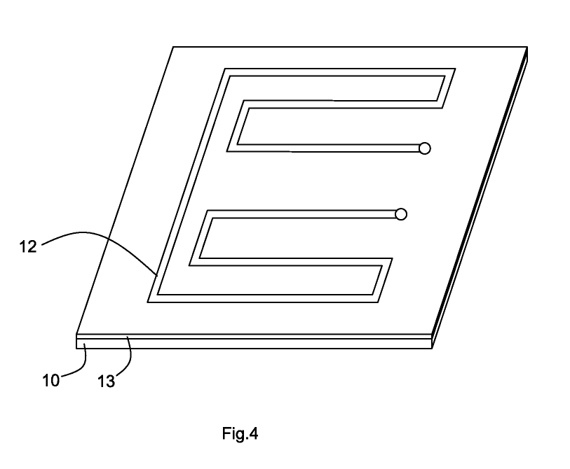

### DETAILED DESCRIPTION OF THE EMBODIMENT

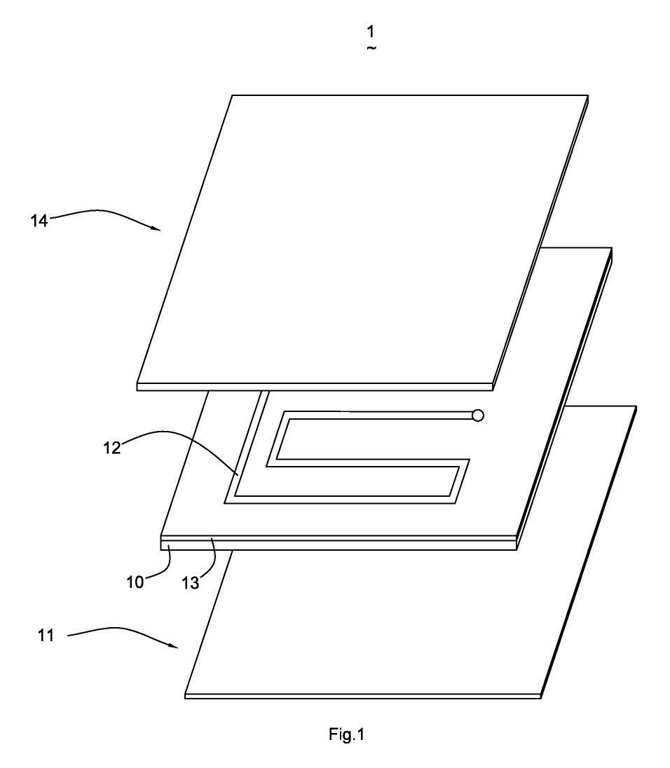

Referring to FIG. 1, an antenna 1 includes a ferrite plate 10, an adhesive layer 13 attached to a first face of the ferrite plate 10, an antenna pattern 12 disposed on the adhesive layer 13, a plastic film 11 attached to a second face of the ferrite plate 10 opposite to the first face, and a double-faced adhesive tape 14 attached to the antenna pattern 12 so that the antenna pattern 12 is able to be pasted to a selected terminal.

The ferrite plate 10 is made from ferrite material. By virtue of it's high resistivity and magnetic permeability, the ferrite plate 10 is able to lead the magnetic field. The plastic film 11 is made from transparent polyester film.

A method for manufacturing the antenna described above comprises the processes below.

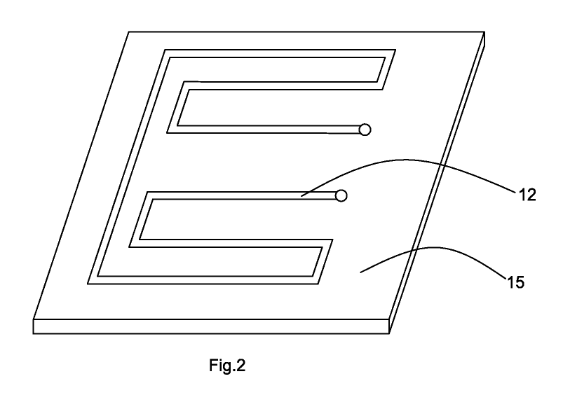

Firstly, referring to FIG. 2, provide a ceramic substrate 15, and forming an antenna pattern 12 on the ceramic substrate 15 using screen printing with metallic material, such as Ag, Ni, Au, Cu, and so on. The ceramic substrate 15 is made from ceramic material, for example aluminium trioxide, silicon-dioxide, zirconium dioxide and so on.

Secondly, co-fire the ceramic substrate 15 and the antenna pattern 12 by temperature ranged from 600° C. to 1300° C.

Thirdly, treat the ceramic substrate 15 and the antenna pattern 12 by chemical wet-etching process.

Fourthly, plate the antenna pattern 12 with metallic material of Ni, Au, Cu, or Ag. Be noted that this process is optional and may be omitted.

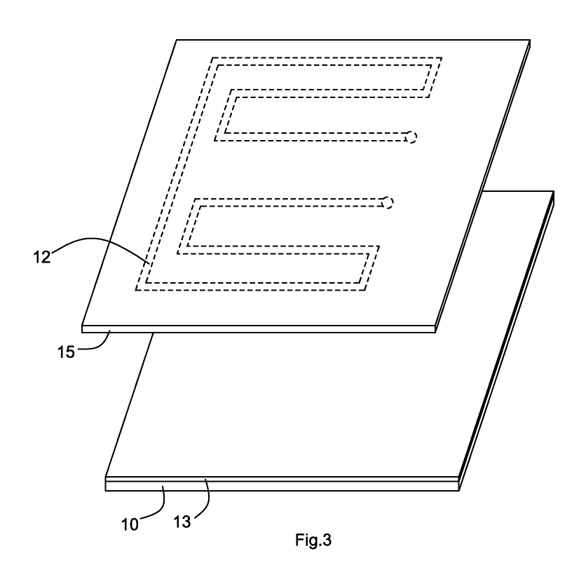

Fifthly, referring to FIG. 3, provide a ferrite plate 10 with an adhesive layer 13 on a first face thereof, paste the ceramic substrate 15 to the ferrite plate 10 with the antenna pattern 11 attached to the adhesive layer 13, and then detach the ceramic substrate 10 from the ferrite plate 10 with the antenna pattern 11 remained on the ferrite plate 10;

Sixthly, referring to FIG. 1, provide a plastic film 11 attached to the second face of the ferrite plate 10, and provide a double-faced adhesive tape 14 attached to the antenna pattern 12.

The antenna 1 according to the present disclosure has a thickness of only 0.03 millimeters which is much smaller than the one made from FPCB. Otherwise, the method is easy for mass production and the cost thereof is accordingly cut down. In addition, the antenna 1 made by the above-mentioned processes has a stable structure and good flexility.

It will be understood that the above-mentioned particular embodiment is shown and described by way of illustration only. The principles and the features of the present disclosure may be employed in various and numerous embodiments thereof without departing from the scope of the disclosure as claimed. The above-described embodiment illustrates the scope of the disclosure but do not restrict the scope of the disclosure.

What is claimed is:

1. A method for manufacturing an antenna, the method comprising the steps of:
providing a ceramic substrate, and forming an antenna pattern on the ceramic substrate using screen printing with metallic material;
co-firing the ceramic substrate and the antenna pattern by a high temperature;
treating the ceramic substrate by chemical wet-etching process;
providing a ferrite plate with an adhesive layer disposed on a first face thereof;
pasting the ceramic substrate to the ferrite plate with the antenna pattern attached to the adhesive layer;
detaching the ferrite plate from the ceramic substrate with the antenna pattern remained on the ferrite plate.

2. The method for manufacturing an antenna as claimed in claim 1, wherein the metallic material for forming the antenna pattern is selected from Ni, Au, Cu, Ag.

3. The method for manufacturing an antenna as claimed in claim 1, wherein the high temperature is ranged from 600° C. to 1300° C.

4. The method for manufacturing an antenna as claimed in claim 2, wherein the antenna pattern is plated with metallic material after being co-fired.

5. The method for manufacturing an antenna as claimed in claim 4, wherein the metallic material plated on the antenna pattern is selected from Ni, Au, Cu, and Ag.

6. The method for manufacturing an antenna as claimed in claim 1, wherein a double-sided adhesive tape is pasted to the antenna pattern.

7. The method for manufacturing an antenna as claimed in claim 6, wherein a plastic film is pasted to a second face of the ferrite plate opposite to the first face.

8. An antenna, comprising:
a ferrite plate including a first face and a second face opposite to the first face;
an adhesive layer disposed on the first face of the ferrite plate;
an antenna pattern attached on the adhesive layer;
and a plastic film disposed on the first face of the ferrite plate.

9. The antenna as claimed in claim 8, wherein the antenna pattern is made from the material selected from Ni, Au, Cu, and Ag.

10. The antenna as claimed in claim 8, wherein a double-faced adhesive tape is disposed on the antenna pattern.

11. The antenna as claimed in claim 8, wherein the plastic film is made from transparent polyester film.
